(19) United States
(12) Patent Application Publication
(10) Pub. No.: US 2008/0278393 A1
(43) Pub. Date: Nov. 13, 2008

(54) Antenna System

(76) Inventors: Frank Gottwald, Weissach (DE); Klaus Voigtlander, Wangen (DE); Tore Toennesen, Reutlingen (DE); Thomas Binzer, Stuttgart (DE)

Correspondence Address: KENYON & KENYON LLP, ONE BROADWAY, NEW YORK, NY, 10004, US

(21) Appl. No.: 11/666,845

(22) PCT Filed: Sep. 8, 2005
(86) PCT No.: PCT/EP05/54463

§ 371 Date: Mar. 19, 2008

(30) Foreign Application Priority Data
Nov. 5, 2004 (DE) 10 2004 053 419.5

(51) Int. Cl. H01Q 19/06

(52) U.S. Cl. 343/753

(57) ABSTRACT

In an antenna system, lens elements are provided in or on the radome for beam formation and/or for influencing the gain of the antenna system.

### FIELD OF THE INVENTION

The present invention is directed to an antenna system having antenna elements on a substrate and a radome at a defined distance from the substrate.

### BACKGROUND INFORMATION

PCT Patent Publication No. WO 01/56 11 89 describes an antenna system having dielectric elements which influence an antenna array by beam focusing, thus acting as lenses.

European Patent Application No. EP 0896 749 describes an antenna system for a motor vehicle radar system having antenna elements on a substrate for components and a dielectric lens at a defined distance upstream therefrom.

### SUMMARY OF THE INVENTION

According to the present invention, i.e., by providing at least one lens element, which is integrated in the radome or attached to the radome, for beam formation and/or for influencing the gain of the antenna system, it is possible to achieve, in addition to the beam formation by the actual antenna array, a beam formation regarding individual antenna elements or groups of antenna elements in a targeted manner. Side lobes may thus be suppressed in a targeted manner without modifying the actual antenna array in any way.

This is important for effectively suppressing undesirable interfering radiation in a predefined frequency range. According to the present invention, compact overall dimensions may be achieved for a radar sensor, while complying with the predefined frequency and/or interfering radiation tolerances.

The present invention provides the possibility to increase the gain of a receiving antenna and thus the sensitivity of a radar sensor, so that the transmitting power does not have to be increased for achieving a greater range. An increase in the transmitting power is usually not an option anyway because the broadband character of a radar system, for example, 4 GHz, would interfere with other wireless services and licensing of the radar system would thus fail.

Using the lens elements, the beam formation predefined by the antenna array may be modified in a targeted manner on both the transmission side and the reception side, i.e., the detection field may be narrowed or widened.

A radome usually provided anyway in motor vehicle applications, to which lens elements are attached or into which they are directly integrated, is used according to the present invention for the system of lens elements.

The approach according to the present invention is advantageously suitable for antenna arrays having subexcited elements, i.e., at least one antenna element being provided at a distance from the substrate of antenna elements, which is excited by at least one of the antenna elements on the substrate. A lens element also capable of influencing and/or compensating tolerances and undesirable interference of this subexcited element may be associated, in a targeted manner, with this antenna element.

The subexcited element(s) may be either attached to the radome or integrated therein.

### BRIEF DESCRIPTION OF THE DRAWINGS

FIG. 1 shows an antenna system having a subexcited antenna element and associated lens element in/on the radome.

FIG. 2 shows a system according to FIG. 1 having a group of subexcited antenna elements and a shared lens element in/on the radome.

FIG. 3 shows an antenna system having a plurality of subexcited antenna elements and lens elements over each subexcited antenna element.

### DETAILED DESCRIPTION

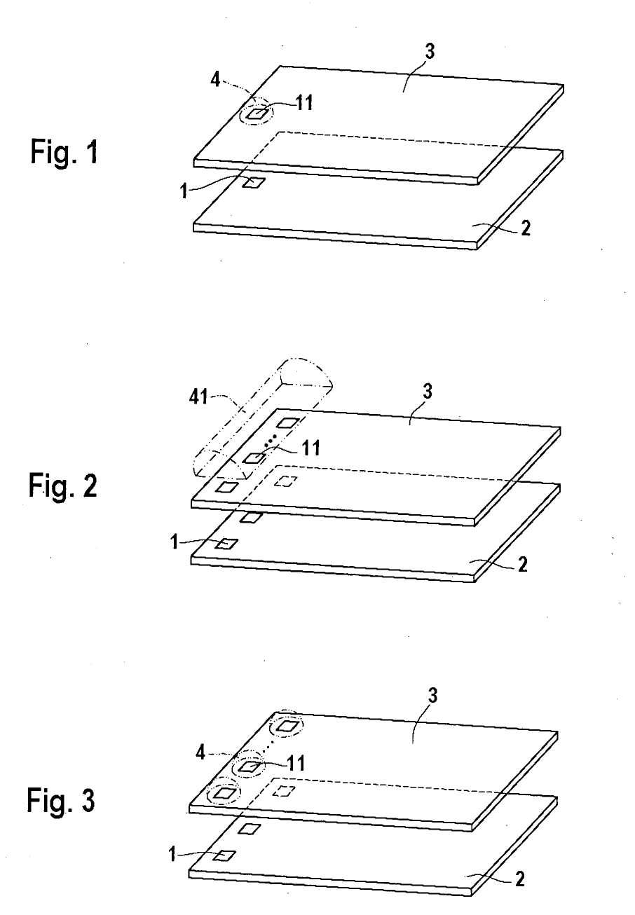

FIG. 1 shows an antenna system according to the present invention. Antenna elements 1 forming an antenna array, for example, are provided on a substrate 2, in particular an RF board. This antenna array makes beam formation of the antenna characteristic and/or the antenna gain possible. Substrate 2 may also have the supply networks, which are advantageously situated on the back side of substrate 2, and are needed for supplying antenna elements 1. A radome 3, which is typically provided in particular in motor vehicle applications for protection against contamination and penetration of moisture, is situated at a defined distance from substrate 2. At least one lens element 4, which is suitable for additional beam formation and/or for increasing the gain and thus the range of the antenna system, is provided on radome 3 or integrated in the radome. The exemplary embodiment according to FIG. 1 shows, in a refinement of the present invention, at least one antenna element 11, which is situated at a distance from substrate 2, i.e., from the plane for the other antenna elements 1. It is excited by at least one antenna element 1 on substrate 2, i.e., it is subexcited. This antenna element 11 may be situated between substrate 2 and radome 3, and secured between substrate 2 and radome 3, for example, in a foam having a low permittivity, or, as FIG. 1 shows, attached to radome 3 or integrated in the radome. In the exemplary embodiment of FIG. 1, lens element 4 is directly associated with antenna element 11 and mounted over antenna element 11. Antenna elements 1 and 11 may be designed as slot elements and/or patch elements. The design of the antenna system provides the possibility of increasing the gain of a receiving antenna and thus the sensitivity of a radar sensor with the aid of a lens element, in such a way that the transmitting power does not have to be increased for achieving a greater range. The lens element or the plurality of lens elements may also be used for beam formation on the transmission and/or reception side.

The lens elements may also be integrated in the radome, e.g.: injected into a PBT radome; they are therefore economical and accurate.

Another advantage of the lens elements is that the side lobes of the receiving or transmitting antennas may be reduced and thus the detection reliability, among other things, may be improved.

The design using lens elements has the advantage over the use of high surface area arrays that less space is required on the RF board for the antenna and also no electric losses occur due to the supply networks needed by the array. This also represents a cost advantage.

Bundling in the elevation and/or azimuth direction is also possible using the antenna system according to the present invention. The material of radome and lens element(s) does not have to be identical.

In the case of the embodiment variant of FIG. 2, a shared lens element 41 is associated with a plurality of antenna elements 11 forming an array or part of an array (antenna columns or antenna rows). In FIG. 2 this is a cylindrical lens which extends over subexciter 11 in or on radome 3 of an antenna column.

In the embodiment variant of FIG. 3, a separate lens element 4 is associated with each subexciter 11 of an antenna column. In the embodiment variants of FIGS. 2 and 3, further antenna columns may be provided with subexciters, including shared and/or separate lens elements 4 or 41. Instead of antenna columns, antenna rows may have subexciters within an array and may carry separate or shared lens elements. Any desired types of beam bundling in the azimuthal and/or elevation direction may thus be set.

The lens element shapes such as, for example, plane-convex or biconvex, may be arbitrarily selected.

Lens shapes, arrangements, and designs for associated antenna elements may be different for the receive and transmit paths in particular. Radome 3 is depicted in the exemplary embodiments as a planar surface. It may, of course, have arbitrarily selected shapes depending on the configuration of the radar sensor or the conditions of installation in the motor vehicle (adjustment to the external contours of the vehicle).

The antenna system according to the present invention is advantageously suitable for increasing the range of a motor vehicle radar system without increasing the transmitting power for a given number of antenna elements and a given array design, such as, for example, a predefined array surface area.

1-10. (canceled)

11. An antenna system comprising:
a substrate;
antenna elements situated on the substrate;
a radome situated at a defined distance from the substrate; and
at least one lens element for at least one of (a) beam formation and (b) influencing a gain of the antenna system, the lens element being one of integrated in the radome and attached to the radome.

12. The antenna system according to claim 11, wherein the at least one lens element includes lens elements situated on or in the radome over antenna elements of an antenna array.

13. The antenna system according to claim 11, wherein at least one of the antenna elements is situated at a distance from the substrate and is excited by at least one of the antenna elements on the substrate.

14. The antenna system according to claim 13, wherein at least one of the antenna elements situated at a distance from the substrate is secured on or in the radome.

15. The antenna system according to claim 13, wherein at least one of the antenna elements situated at a distance from the substrate is embedded in a medium.

16. The antenna system according to claim 15, wherein the medium includes a foam of low permittivity.

17. The antenna system according to claim 11, wherein the antenna elements include at least one of patch antenna elements and slot antenna elements.

18. The antenna system according to claim 11, wherein the lens elements have one of a plane-convex and biconvex design.

19. The antenna system according to claim 11, wherein the at least one lens element includes a shared lens element for a group of antenna elements, including one of a column and a row of an antenna array.

20. The antenna system according to claim 11, wherein lens shapes, arrangements, and designs are different for antenna elements of receive and transmit paths.

21. The antenna system according to claim 11, wherein the antenna system is used for increasing a range of a motor vehicle radar system without increasing a transmitting power.
